(19) United States
(12) Patent Application Publication
(10) Pub. No.: US 2024/0362148 A1
(43) Pub. Date: Oct. 31, 2024

(54) SYSTEM AND METHOD FOR CONSOLE DEBUG MODE FOR USE WITH CUSTOMIZING CLOUD ENVIRONMENTS

(71) Applicant: ORACLE INTERNATIONAL CORPORATION, Redwood Shores, CA (US)

(72) Inventors: Abishek Murali Mohan, Kirkland, WA (US); Amit Kumar, Seattle, WA (US)

(21) Appl. No.: 18/639,788

(22) Filed: Apr. 18, 2024

Related U.S. Application Data
(60) Provisional application No. 63/462,868, filed on Apr. 28, 2023.

(51) Int. Cl. G06F 11/36

(52) U.S. Cl. CPC G06F 11/362

(57) ABSTRACT

Systems and methods described herein provide for a debug mode customizable console, for us in providing or customizing cloud environments. Cloud computing offerings enable access within the context of a cloud environment by third-party operators acting as resellers of products or services owned or managed by a cloud provider. An operator provides access to their customers via consoles that are customizable by the operators to enable greater control over their cloud-based products and services. A debug mode can be provided for use with such customized consoles in order to quickly identify and resolve.

### CLAIM OF PRIORITY AND CROSS-REFERENCE TO RELATED APPLICATIONS

This application claims the benefit of priority to U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,868, filed Apr. 28, 2023; and is related to U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,875, filed Apr. 28, 2023; U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,878, filed Apr. 28, 2023; U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,880, filed Apr. 28, 2023; U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,882, filed Apr. 28, 2023; and U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,885, filed Apr. 28, 2023; each of which above applications and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to systems and methods for providing cloud environments, for use by tenants of a cloud infrastructure environment in accessing software products, services, or other offerings associated with the environment, including providing a console debug mode for custom console.

### BACKGROUND

A cloud computing environment can be used to provide access to a range of complementary cloud-based components, such as software applications or services, that enable organizations or enterprise customers to operate their applications and services in a highly-available hosted environment.

The benefits to an organization in moving their application and service needs to a cloud environment include a reduction in the cost and complexity of designing, building, operating, and maintaining their own on-premise data center, software application framework, or other information technology infrastructure; allowing them to instead focus on managing their day-to-day business.

### SUMMARY

In some cloud environments, it is desirable to provide mechanism to allow customization of a console, such as a console provided by a cloud environment. This allows for the customization of a look and feel of, for example, a publicly accessible page or console or a page that is accessible by customers. Such customization is desirable in order to, for example, promote brand identity and loyalty, or to promote efficient identification of a brand or ownership of a page or console.

Embodiments described herein are generally related to systems and methods for providing cloud environments, for use by tenants of a cloud infrastructure environment in accessing software products, services, or other offerings associated with the environment, including customizing a cloud console.

Systems and methods described herein provide for a customizable console. Cloud computing offerings (e.g., private label cloud computing offerings) enable access within the context of a cloud environment by third-party operators acting as resellers of products or services owned or managed by a cloud provider. An operator provides access to their customers via consoles that are customizable by the operators to enable greater control over their cloud-based products and services.

In accordance with an embodiment, a method can provide a computer comprising a microprocessor. The method can provide a customizable console within the context of a cloud environment, the customizable console providing access to subscription-based products, services, and other offerings. The method can provide access to the customizable console within the context of the cloud environment. The method can customize, by a first entity associated with a first tenancy of the cloud environment, the customizable console via a configuration service, wherein the configuration service generates a console configuration resource in response to received instructions from the first entity associated with the first tenancy, the generated console configuration resource being utilized in customizing the customizable console when access is provided to the customizable console.

In accordance with an embodiment, a method can provide a computer comprising a microprocessor. The method can provide a customizable console within the context of a cloud environment, the customizable console providing access to subscription-based products, services, and other offerings. The method can customize the customizable console via a configuration service, wherein the configuration service generates a console configuration resource in response to received instructions. The method can, based upon the generated console configuration resource, generate a modified preview of a console comprising a plurality of console elements based upon the generated console configuration resource for use in debugging the generated console configuration resource.

### BRIEF DESCRIPTION OF THE DRAWINGS

FIG. 1 illustrates a system for providing a cloud infrastructure environment, in accordance with an embodiment.

FIG. 2 further illustrates how a cloud infrastructure environment can be used to provide cloud-based applications or services or services, in accordance with an embodiment.

FIG. 3 illustrates an example cloud infrastructure architecture, in accordance with an embodiment.

FIG. 4 illustrates another example of a cloud infrastructure architecture, in accordance with an embodiment.

FIG. 5 illustrates another example of a cloud infrastructure architecture, in accordance with an embodiment.

FIG. 6 illustrates another example of a cloud infrastructure architecture, in accordance with an embodiment.

FIG. 7 illustrates a system that provides dedicated or private label cloud environments, for use by tenants or customers of a cloud infrastructure environment, in accordance with an embodiment.

FIG. 8 further illustrates the use of cloud realms, for use by tenants or customers of a cloud infrastructure environment, in accordance with an embodiment.

FIG. 9 further illustrates the use of cloud realms, for use by tenants or customers of a cloud infrastructure environment, in accordance with an embodiment.

FIG. 10 illustrates a system for providing access to software products or services in a cloud computing or other computing environment, in accordance with an embodiment.

FIG. 11 illustrates an architecture for providing console customization, in accordance with an embodiment.

FIG. 12 depicts multiple paths for providing console customization, in accordance with an embodiment.

FIG. 13 is a lifecycle diagram for backend resources for console customization, in accordance with an embodiment.

FIG. 14 is a depiction of a user interface for console customization, in accordance with an embodiment.

FIG. 15 is a depiction of a user interface for console customization, in accordance with an embodiment.

FIG. 16 is a depiction of a user interface for console customization, in accordance with an embodiment.

FIG. 17 depicts a color space used for custom palette generation for console customization, in accordance with an embodiment.

FIG. 18 is a flowchart of a method for customizable console generation, in accordance with an embodiment.

FIG. 19 illustrates an architecture for providing debug mode for console customization, in accordance with an embodiment.

FIG. 20 shows a screenshot of debug mode, in accordance with an embodiment.

FIG. 21 is a flowchart of a method for console debug mode for custom console, in accordance with an embodiment.

### DETAILED DESCRIPTION

A cloud computing or cloud infrastructure environment can be used to provide access to a range of complementary cloud-based components, such as software applications or services, which enable organizations or enterprise customers to operate their applications and services in a highly-available hosted environment.

The benefits to an organization in moving their application and service needs to a cloud infrastructure environment include a reduction in the cost and complexity of designing, building, operating, and maintaining their own on-premise data center, software application framework, or other information technology infrastructure; allowing them to instead focus on managing their day-to-day business.

### Cloud Infrastructure Environments

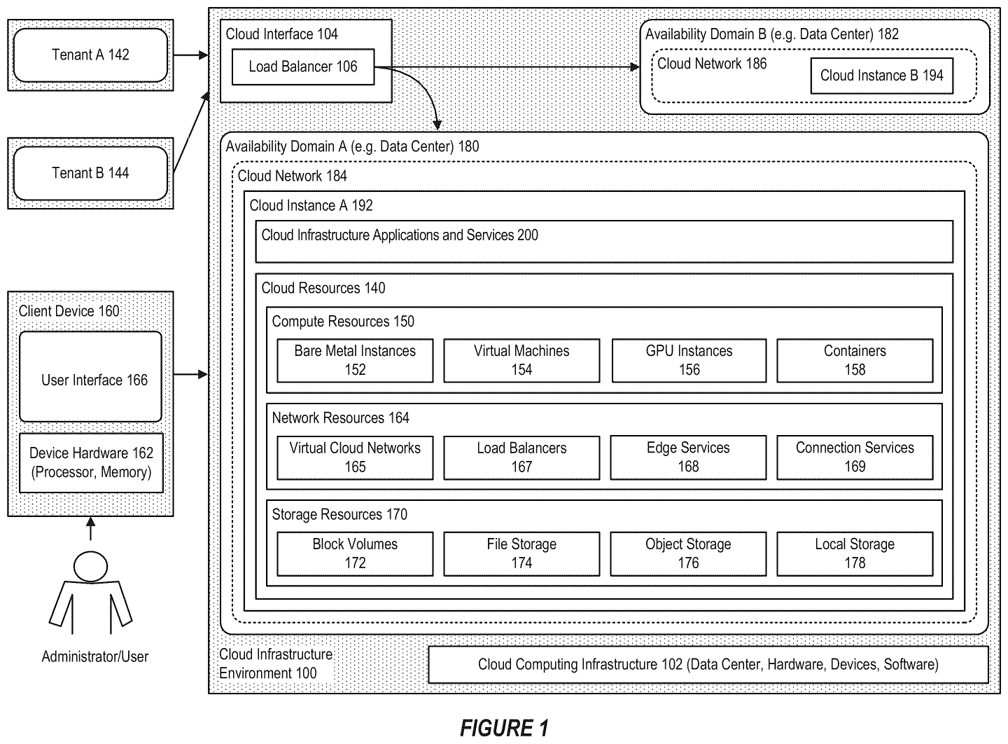

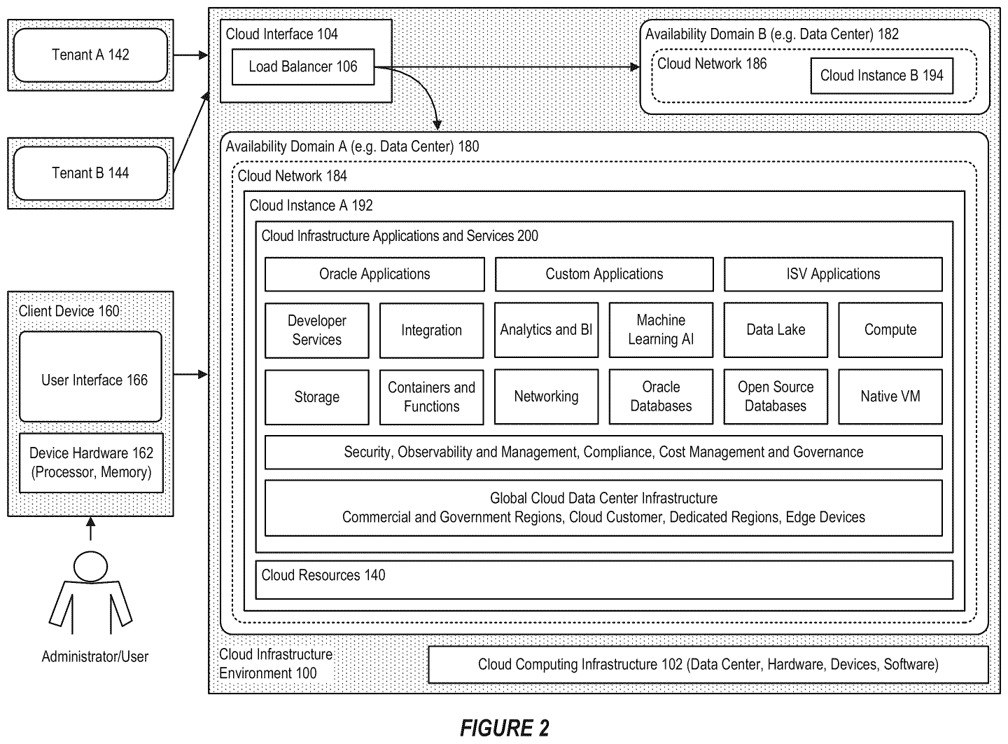

FIGS. 1 and 2 illustrate a system for providing a cloud infrastructure environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers 106.

In accordance with an embodiment, the cloud infrastructure environment supports the use of availability domains, such as, for example, availability domains A 180, B 182, which enables customers to create and access cloud networks 184, 186, and run cloud instances A 192, B 194.

In accordance with an embodiment, a tenancy can be created for each cloud tenant/customer, for example tenant A 142, B 144, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 160 having a device hardware 162 (e.g., processor, memory), and graphical user interface 166, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 140 via, for example, a compute resources layer 150, a network resources layer 164, and/or a storage resources layer 170. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 152, virtual machines 154, graphical processing unit (GPU) compute cloud instances 156, and/or containers 158. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 165, load balancers 167, edge services 168, and/or connection services 169.

In accordance with an embodiment, the storage resources layer can comprise a number of resources, such as, for example, data/block volumes 172, file storage 174, object storage 176, and/or local storage 178.

As illustrated in FIG. 2, in accordance with an embodiment, the cloud infrastructure environment can include a range of complementary cloud-based components, for example as cloud infrastructure applications and services 200, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

For example, in accordance with an embodiment, such an environment can include racks physically and managed by a cloud infrastructure provider; customer's racks; access for cloud operations personnel for setup and hardware support; customer's data center power and cooling; customer's floor space; an area for customer's data center personnel; and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's public cloud regions, such as, for example, ERP, Financials, HCM, and SCM. A customer can seamlessly lift and shift legacy workloads using the cloud infrastructure provider's services, for example bare metal compute, VMs, and GPUs; database services, for example Autonomous Database; or container-based services, for example Container Engine for Kubernetes.

In accordance with an embodiment, a cloud infrastructure environment can operate according to infrastructure-as-a-service (IaaS) model that enables the environment to provide virtualized computing resources over a public network (e.g., the Internet).

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components (example services include billing software, monitoring software, logging software, load balancing software, or clustering software). Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not be, a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries, or daemons). This is often managed by the cloud infrastructure provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In accordance with an embodiment, IaaS provisioning may refer to acquiring computers or virtual hosts for use, and even installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

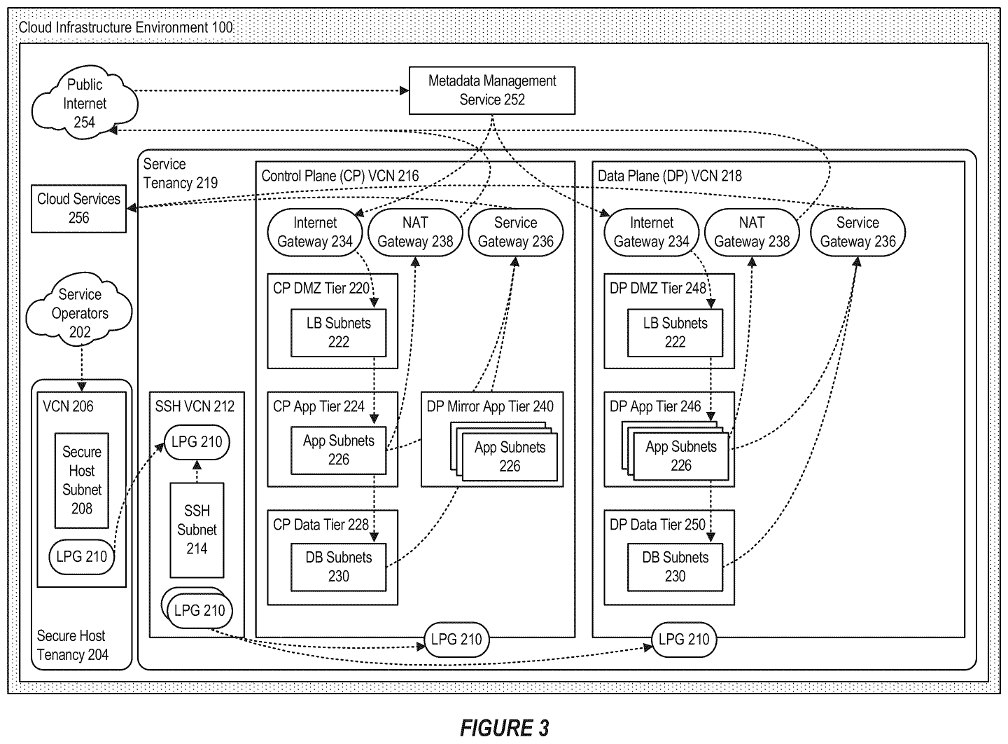

FIG. 3 illustrates an example cloud infrastructure architecture, in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices, which may be portable handheld devices (e.g., a telephone, a computing tablet, a personal digital assistant (PDA)) or wearable devices (e.g., a head mounted display), running software such as Microsoft Windows, and/or a variety of mobile operating systems such as iOS, Android, and the like, and being Internet, e-mail, short message service (SMS), or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Chrome. Alternatively, or in addition, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnet(s) 222, a control plane app tier 224 that can include app subnet(s) 226, and a control plane data tier 228 that can include database (DB) subnet(s) 230 (e.g., frontend DB subnet(s) and/or backend DB subnet(s)). The LB subnet(s) contained in the control plane DMZ tier can be communicatively coupled to the app subnet(s) contained in the control plane app tier, and an Internet gateway 234 that can be contained in the control plane VCN, and the app subnet(s) can be communicatively coupled to the DB subnet(s) contained in the control plane data tier and a service gateway 236 and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier 246, a data plane DMZ tier 248, and a data plane data tier 250. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way: the service gateway can make API calls to cloud services, and cloud services can send requested data to the service gateway. Generally, cloud services may not initiate API calls to the service gateway.

In accordance with an embodiment, the secure host tenancy can be directly connected to the service tenancy, which may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example create, read, update, or delete (CRUD) operations, through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both of which may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage, which may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy, which may be isolated from the public Internet.

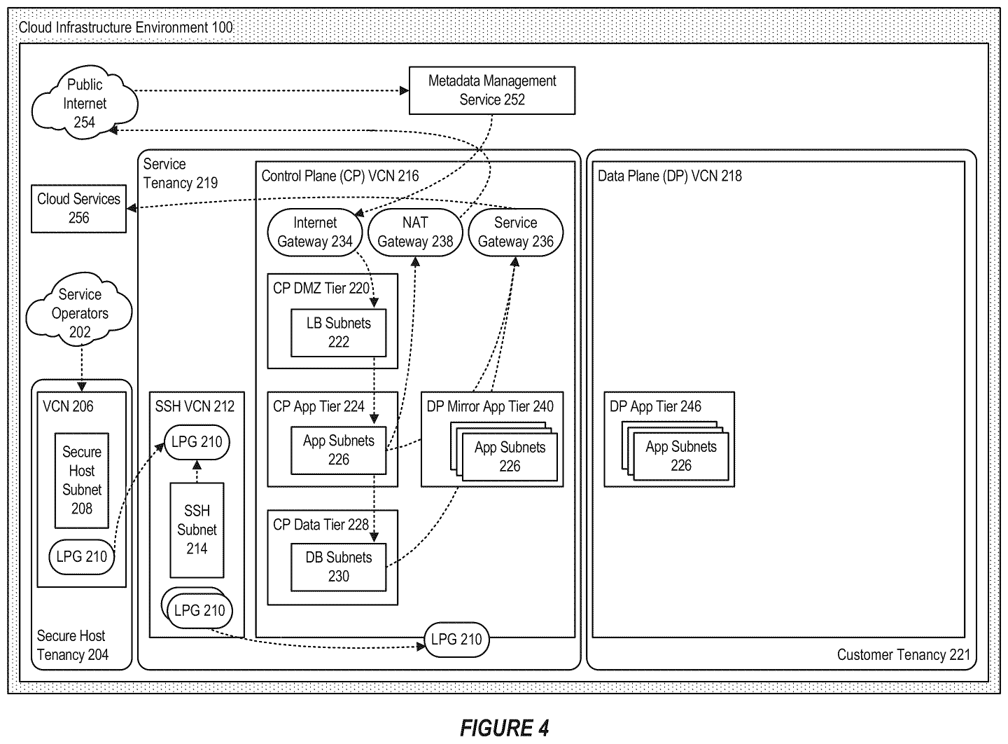

FIG. 4 illustrates another example of a cloud infrastructure architecture, in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources that are provisioned in the control plane VCN that is contained in the service tenancy, to be deployed or otherwise used in the data plane VCN that is contained in the customer tenancy.

In accordance with an embodiment, a customer of the cloud infrastructure provider may have databases that are managed and operate within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, of the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with Deployment 1 in Region 2.

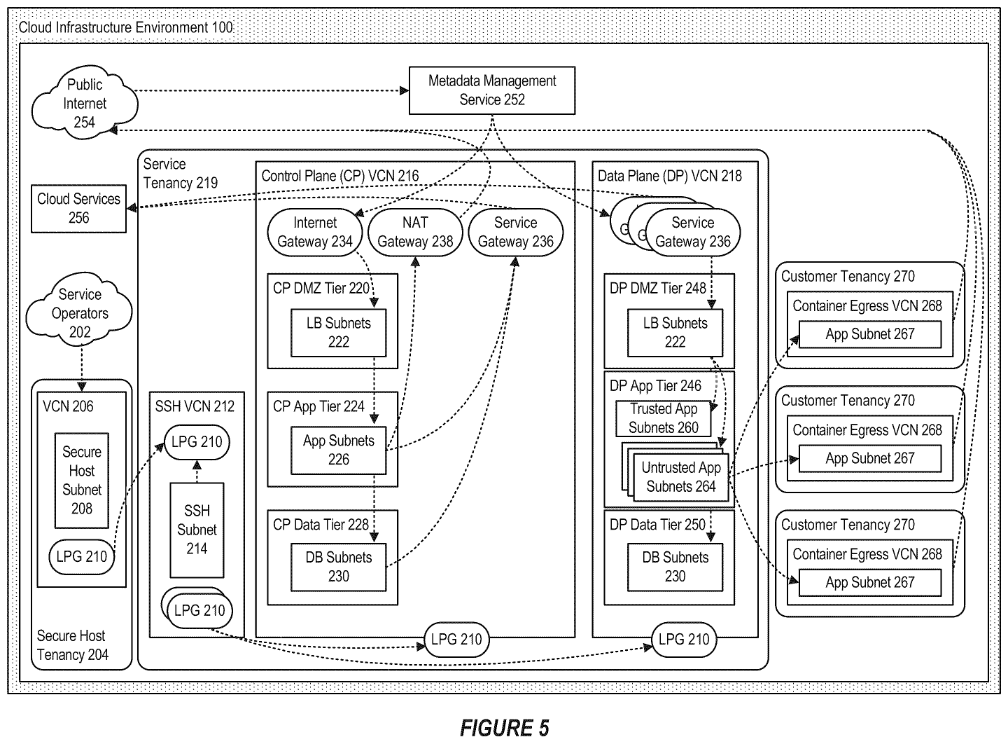

FIG. 5 illustrates another example of a cloud infrastructure architecture, in accordance with an embodiment.

As illustrated in FIG. 5, in accordance with an embodiment, the trusted app subnet(s) 260 can be communicatively coupled to the service gateway contained in the data plane VCN, the NAT gateway contained in the data plane VCN, and DB subnet(s) contained in the data plane data tier. The untrusted app subnet(s) 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs, and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)), which may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s), and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled; or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

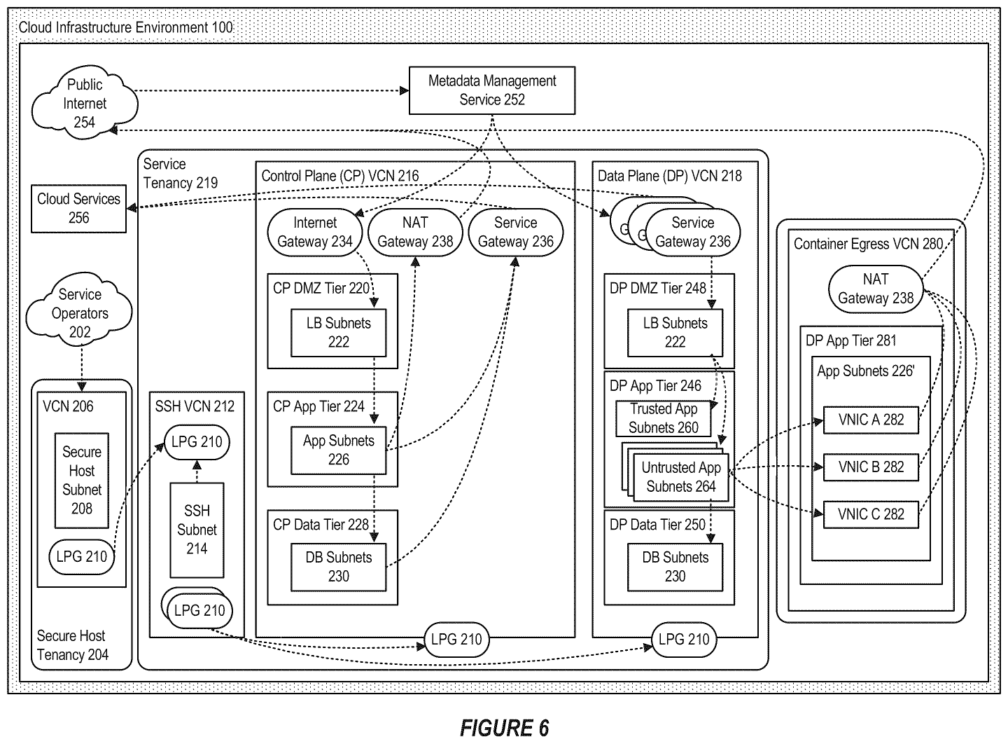

FIG. 6 illustrates another example of a cloud infrastructure architecture, in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container, and be communicatively coupled to an app subnet that can be contained in a data plane app tier 281 that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that requests a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Cloud Environments

In accordance with an embodiment, a cloud infrastructure environment can be used to provide dedicated cloud environments, for example as one or more private label cloud environments, for use by tenants of the cloud infrastructure environment in accessing subscription-based software products, services, or other offerings associated with the cloud infrastructure environment.

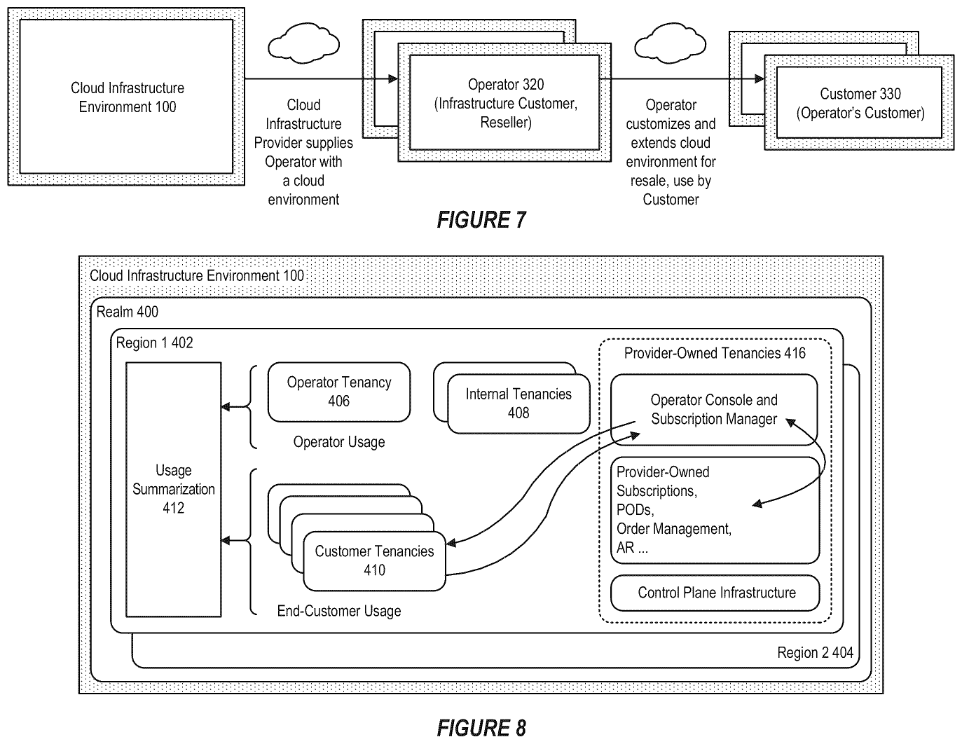

FIG. 7 illustrates how the system can provide dedicated or private label cloud environments, for use by tenants or customers of a cloud infrastructure environment, in accordance with an embodiment.

Although several of the examples described herein illustrate various systems, methods, and/or techniques as may be used in the context of providing private label cloud (PLC) environments, in accordance with various embodiments, the systems, methods, and techniques described herein can be used, within or with other types of cloud environments.

As illustrated in FIG. 7, in accordance with an embodiment, a cloud infrastructure provider can supply an operator 320, for example a cloud infrastructure customer operating as a reseller, with one or more cloud environments (e.g., a PLC environment) or realms. The operator/reseller can then customize and extend the cloud environment for use by (their) customer 330, for use in accessing subscription-based software products, services, or other offerings associated with the cloud infrastructure environment.

For purposes of illustration, examples of such subscription-based products, services, or other offerings may include various cloud infrastructure software products, such as Oracle Fusion Applications products, or other types of products or services that allow customers to subscribe to usage of those products or services.

FIG. 8 further illustrates the use of cloud realms, for use by tenants or customers of a cloud infrastructure environment, in accordance with an embodiment.

As illustrated in FIG. 8, in accordance with an embodiment, the system can include a cloud subscription service or component, referred to herein in some embodiments as a subscription manager, that exposes one or more subscription management APIs for creating orders used to onboard new customers, or to launch a workflow that creates a subscription and orchestrates billing and pricing service or other components for use with a cloud realm 400.

In accordance with an embodiment, when an operator (e.g., a PLC operator) or their customer requests a cloud environment, the system creates a realm, for use within a region 402, 404; together with one or more provider-owned tenancies 416. These tenancies allow a region to function with its required service infrastructure; and are administered by the cloud infrastructure provider.

In accordance with an embodiment, a first step in the process is to create an operator tenancy 406 for the operator, before the region and associated realms are turned over to them for subsequent management. The operator then becomes the administrator of this tenancy, within which they can view and manage everything that happens within that region, including their customer accounts and usage 412 by those customers of cloud resources.

Generally, once the region has been turned over or provided to the operator, the cloud infrastructure provider cannot subsequently access the data within the operator tenancy, unless the operator authorizes the cloud infrastructure provider to do so, for example to provide troubleshooting of issues that may arise.

In accordance with an embodiment, the operator can then create additional internal tenancies 408, intended for their own use internally, for example to assess what the end user or customer experience will be, or to provide a sales demo tenancy, or to operate a database for their own internal use. The operator can also create one or more customer tenancies 410, of which the end user or customer will be the administrator. Cloud infrastructure usage, for example compute, storage, and other infrastructure resources, is consolidated by operator, reflecting both their usage and that of their customers, and reported to the cloud infrastructure provider.

In accordance with an embodiment, a user interface or console can be provided that allows the operator to manage its customer accounts and customer-offered services. A cloud infrastructure provider can also use a cloud infrastructure tenancy, for example a Fusion Applications tenancy, to install any needed infrastructure services for use by the operator and their customers.

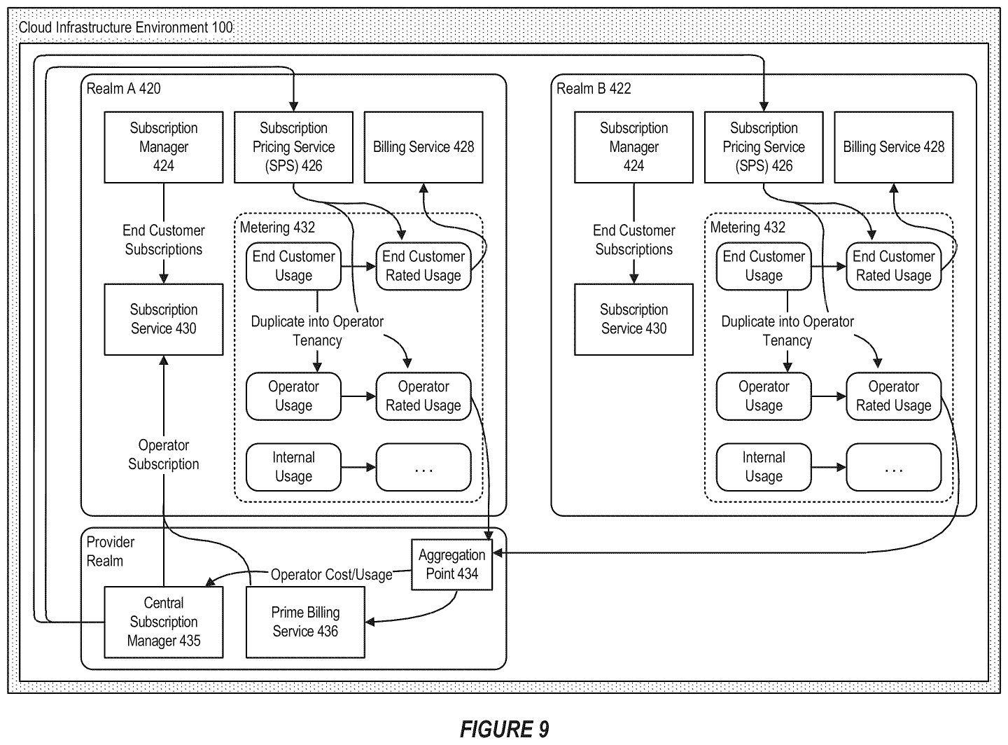

FIG. 9 further illustrates the use of cloud realms, for use by tenants or customers of a cloud infrastructure environment, in accordance with an embodiment.

As illustrated in FIG. 9, in accordance with an embodiment, a subscription manager 424 service or component exposes one or more subscription management APIs for creating orders used to onboard new customers, or to launch a workflow that creates a subscription and orchestrates billing and pricing service or other components.

In accordance with an embodiment, the system can also include a billing service 428 or component that operates upon a billing account or logical container of subscriptions and preferences used to produce an invoice for a customer.

In accordance with an embodiment, the system can also include a subscription pricing service (SPS) 426 or component, which operates upon a product catalog that defines which products can be purchased by a customer, and can be used to provide a price list (e.g., a rate card) that the pricing service also owns.

In accordance with an embodiment, to support the sales process through which a subscription is created in a realm 420, 422, products can be selected from a product hub. Once an order is created via a subscription service 430, a subscription is created in the subscription manager which thereafter manages the life cycle of that subscription, and provisions what needs to be provisioned in downstream services. The SPS component then manages the aspects of pricing and usage, for use in charging the end cost to the operator or their ability to charge their customers. Usage events are forwarded to the billing service or component, where depending on the billing preferences of the subscription, invoices are created and pushed to an accounts receivables component.

In accordance with an embodiment, although the services that are offered in a realm report their usage to a metering service or component 432, such usage does not have any price associated with it. A rating process determines how much each specific event costs, for example by applying rate cards, determines a unit and cost for that subscription, associates the cost to that record, and then forwards that to the billing service or component.

As further illustrated in FIG. 9, in accordance with an embodiment, an operator may control multiple realms A, B—for example an operator that operates in multiple countries may wish to operate a data center that is completely isolated for the United States of America, and a separate data center that is completely isolated for Europe, for example to address governance or regulatory requirements. In accordance with an embodiment, the usage associated with these multiple realms can be aggregated 434, for use by a central subscription manager 435, and where applicable a prime billing service 436, in billing the operator.

The examples of various systems illustrated above are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Cloud Subscriptions

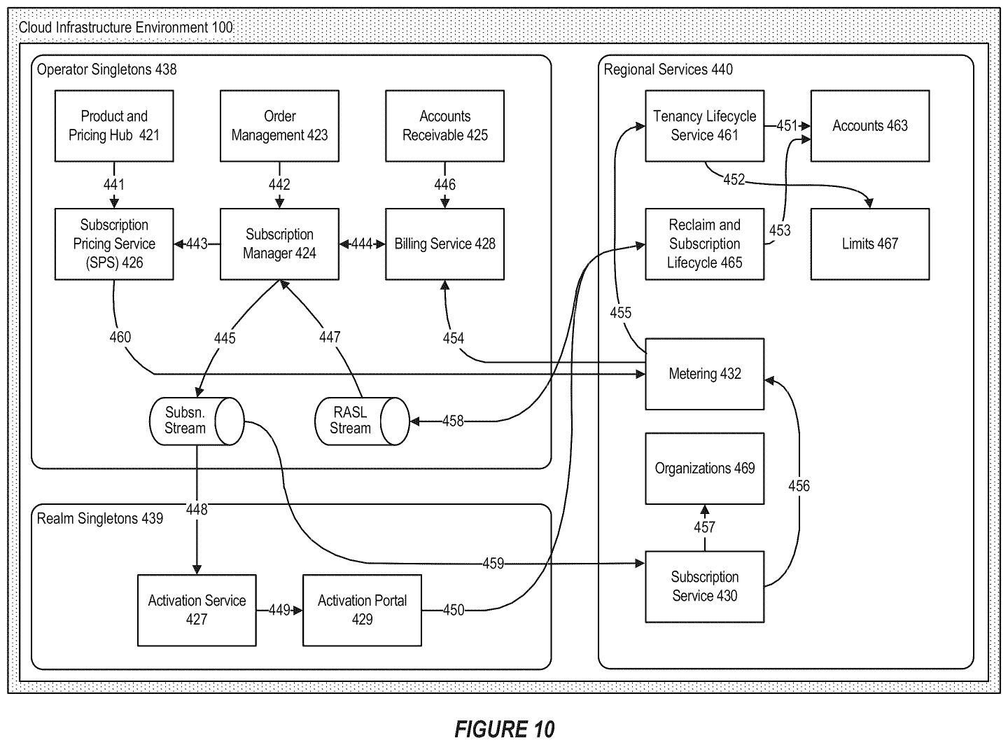

FIG. 10 illustrates a system for providing access to software products or services in a cloud computing or other computing environment, in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various cloud infrastructure software products or services that allow customers to subscribe to usage of those products or services.

In accordance with an embodiment, the environment can include a plurality of components provided as operator singletons 438, realm singletons 439, and regional services 440, as further described below.

In accordance with an embodiment, a subscription can include artifacts such as, for example, products, commits, billing model, and state. The subscription manager service or component can expose one or more subscription management APIs for creating orders used to onboard new customers, or to launch a workflow that creates a subscription and orchestrates creating the proper footprints in billing and pricing service or components, as further described below.

In accordance with an embodiment, the billing service or component operates upon a billing account or logical container of subscriptions and preferences used to produce an invoice. Each billing account generates one invoice per billing cycle. The billing service includes a first pipeline that accepts usage and cost from a metering service or component through a REST API, wherein billing writes the usage to a database from which billing workers aggregate and calculate balances; and a second pipeline responsible for taking the aggregated usage and commitments and calculating charges over a billing interval.

In accordance with an embodiment, the subscription pricing service (SPS) 426 or component operates upon a product catalog that defines which products can be purchased by a customer. The product catalog forms the backbone of a price list (i.e., rate card) that the pricing service also owns. Rate cards are modeled as pricing rules on top of public list prices. The pricing service maintains a single price list for all products, new product prices can be added, and existing prices changed. The price list has a full history, the latest version being the current rate card. Since some contracts may require a snapshot of the rate card be taken, the pricing service handles this by recording the time a customer's rate card is created, and then querying the price list at that time.

In accordance with an embodiment, the SPS or pricing service is responsible for communicating with a product and pricing hub 421, to provide information about products, global price list, and end user or customer's subscription specific price lists and discounts. For example, in accordance with an embodiment, SPS can synchronize product information from a product hub, and a global price list from a pricing hub.

In accordance with an embodiment, the subscription manager service or component operates as an upstream service to receive new order requests from an order management 423 component, for example from an Oracle Fusion Order Management environment. The subscription manager service or component can provide subscription information to the SPS service, including subscription details such as time of quote configured, or subscription type (Commitment, PayG), to help SPS to determine an effective base price (Rate Card) for the subscription. The subscription manager service or component can also send discounts for subscriptions received from the order management component, which SPS stores as a pricing rule entity.

In accordance with an embodiment, the SPS service runs as a background process to manage a rate cards service or component, which is responsible for generating rate cards for new subscriptions and updating those rate cards when new price changes occur. The SPS service can provide APIs to access rate cards and pricing rules. A metering in-line rating engine can utilize these APIs to obtain subscription-specific rate cards and pricing rules, and then use this data for cost calculations.

In accordance with an embodiment, additional SPS components can include, for example, a pricing/product hub integration component, that allows an operator entity providing subscription-based products, services, or other offerings within the environment, to manage their product and price list, for example as provided by a product hub and pricing hub respectively.

For example, in accordance with such an embodiment, an SPS product integration flow can listen to create/update events in the product hub and make calls to an SPS product API. Similarly, an SPS pricing integration flow can pull new price list creation from the pricing hub and call respective SPS pricing APIs.

In accordance with an embodiment, the system can also include an SPS core module that provides APIs to manage and access pricing entities. Pricing entities can be accessed by internal services, for example an inline rating engine.

In accordance with an embodiment, the system can also include a rate card manager component. The SPS service maintains the single base price for a product at a given time. However, product prices for subscription are dependent on a base price at quote configuration time and price list change policy attributes of subscriptions. The SPS service internally maintains the price to be used for subscription using these properties. All such price lists are grouped in a rate card. The rate card manager can create and maintain the rate card, listen to price list changes and update existing rate cards with the new price, and listen to new subscriptions and assigns the rate card based on subscription properties.

In accordance with an embodiment, the SPS service is responsible for managing pricing rules for a subscription, including discounts offered to an end user or customer. Pricing rules eligibility can be based on attributes of products, such as discount group, product category or specific SKUs. Internally SPS needs to identify the list of products for which these rules will be applicable. To accomplish this, a rule decoder engine can compile the pricing rules in a format such that an in-line rating engine can consume the information for cost calculation. This compilation process can be triggered when products or pricing rules are created or updated.

As illustrated by way of example in FIG. 10, in accordance with an embodiment: at 441, a product and price information managed in, e.g., Fusion Applications, is sent to the SPS component.

At 442, orders are sent to the subscription manager component to create subscriptions, rate cards and billing accounts.

At 443, pricing configuration and pricing rules are sent to SPS for new orders.

At 444, the subscription manager component is used to set up a billing account in the billing service or component.

At 445, the subscription manager component publishes events to a subscription manager streaming component.

At 446, a charge data is sent to an accounts receivable component 425 to generate invoices.

At 447, the subscription manager component consumes reclaim and subscription lifecycle (RASL) events from subscription manager streaming.

At 448, an activation service 427 reads the subscription manager event stream. At 449, a customer obtains activation data from an activation portal 429.

At 450, a tenancy lifecycle service 461 provisions a tenancy as part of the subscription activation.

At 451, the tenancy lifecycle service creates, within an accounts 463 component, an accounts footprint during account provisioning.

At 452, the tenancy lifecycle service sets, within a limits service 467, a limits template during account provisioning.

At 453, the accounts component acts as a downstream RASL client to handle a legacy reclamation and subscription lifecycle 465.

At 454, aggregated cost and usage is sent to the billing service 428 or component.

At 455, an organization can create child tenancies using the tenancy lifecycle service.

At 456, a metering service 432 or component obtains subscription mapping data.

At 457, the subscription service 430 obtains organization data 469 for subscription mappings.

At 458, the RASL component reads the subscription manager event stream.

At 459, the subscription service reads the subscription manager event stream; and at 460, the metering service or component obtains a rate card data for each subscription, which can then be used in charging the end cost to the operator or their ability to charge their customers.

The above examples are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Console Customization

In accordance with an embodiment, as described above, the described systems and methods can provide cloud computing capabilities, such as via a private label cloud, to operators. These operators can, via such cloud computing systems and methods, offer cloud infrastructure services to their own customers (e.g., end users), including the use of a cloud console that can serve as a landing platform for the operator's end customers.

In accordance with an embodiment, the systems and methods described herein provide (e.g., to operators) the tools necessary to customize and/or rebrand a cloud console to provide the ability to customize the look and feel of instances of the cloud console. As an example, the tools are provided to customize a cloud console in order to match a brand or theme desired by an operator. Customizations can include, but are not limited to, colors, logos, or aliased product labeling.

In accordance with an embodiment, the systems and methods described herein provide operators with tools to cohesively manage their realms, configure the way their cloud services are delivered to customers (e.g., subscriptions, pricing, billing) and to customize the console's look-and-feel (e.g., logo, colors, branding). The systems and methods described also provide the ability to control access, manage services, view service health, and troubleshoot issues, for example, in partnership with a could provider. The custom console provides a mechanism to enable the operator to brand their console and centrally-access tools for managing their cloud environment.

In accordance with an embodiment, an operator console can be based upon a scalable and federated platform, similar to a cloud infrastructure console. By basing it on a scalable and federated platform, this allows a cloud infrastructure provider to provide access to tools for the operator platform in the form of plugins, which increases and ensures stability with respect to operations performed within the scope of the operator console. This delivery model also enables operators to easily develop and release their own services to customers, because operators can build their own plugins that can be added (e.g., after passing certain tests and stability methods) to the operator console, giving operators more customization and flexibility within the provided operator console.

In accordance with an embodiment, the systems and methods can ingest and store an operator's customized rebranding (e.g., logo, color scheme, texts (e.g., copyright, terms & conditions, service names), via an implemented backend that can process and store these customizations in persistent storage where the console can access them. Upon publishing/access thereof, the console can pull from such backend storage in order to publish a user interface that comprises the operator's customizations that have been selected and configured via the console UI.

Although several of the examples described herein illustrate various systems, methods, and/or techniques as may be used in the context of providing private label cloud (PLC) environments, in accordance with various embodiments, the systems, methods, and techniques described herein can be used, within or with other types of cloud environments.

### Console Architecture

In accordance with an embodiment, a user experience configuration service (referred to herein in some embodiments as a UX configuration service) can comprise a control plane service (e.g., a low traffic service) provided as a serverless application using an API, such as an API gateway, as well as cloud provider functions. In addition, the configuration service can be fronted by a proxy (e.g., a service platform, SPLAT Proxy), which can handle certain aspects of authentication, authorization, as well as load balancing (e.g., authentication via one more methods such as authentication via an authentication service, authorization via one more methods such as authorization via an authorization process, auditing and logging, and load balancing via throttling).

In accordance with an embodiment, an API gateway can expose a public endpoint (although not necessarily customer accessible) which can be referred to as a Splat proxy. This endpoint can be protected by an authentication method (e.g., mTLS, method for mutual authentication). To prevent attacks (e.g., DDoS), the systems and methods can utilize an API gateway provided rate-limiting feature. The invocation of the cloud infrastructure provider functions can be controlled by an internal identity and access management service, or other similar service, such that only the API gateway created in the configured service tenancy is able to invoke the cloud infrastructure provider function endpoints.

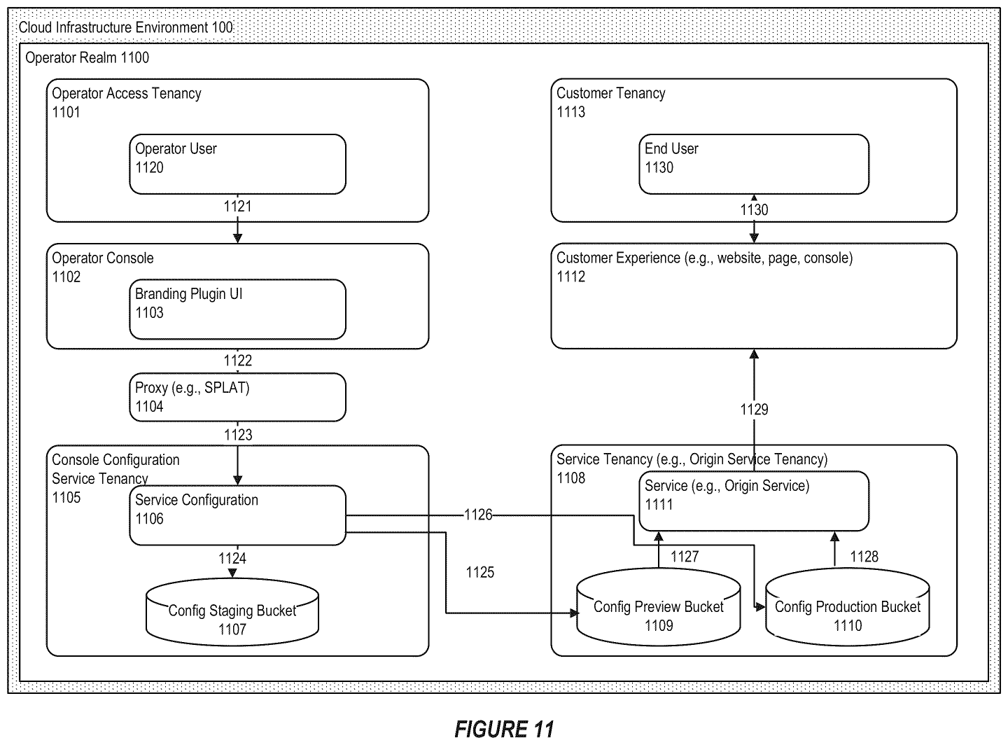

FIG. 11 illustrates an architecture for providing console customization, in accordance with an embodiment.

As illustrated in FIG. 11, in accordance with an embodiment, within a cloud infrastructure environment 100, there can be provided/defined an operator realm 1100, which can be associated with an operator of the cloud infrastructure environment, such as that described above. A cloud infrastructure provider can supply an operator, for example a customer operating as a reseller, with one or more cloud environments (e.g., private label cloud environments), which can have defined therein an operator realm 1100.

In accordance with an embodiment, defined within or in relation to the operator realm there can be a number of tenancies, such as an operator access tenancy 1101, a console configuration service tenancy 1105, a service tenancy 1108, and a customer tenancy 1113.

In accordance with an embodiment, from an operator access tenancy 1101, a user, such as a user of the operator 1120, can interact with an operator console 1102 via a, for example, branding plugin user interface 1103. This can be in the form of, for example, a privately accessible website that provides, via the branding plugin user interface, customization options for the operator's website that is hosted at/provided by the cloud infrastructure environment 100.

In accordance with an embodiment, at 1121, an operator or an authorized user of the operator, such as an operator user 1120, can interact with the branding plugin, e.g., via a web interface or other API, within the operator console 1102.

In accordance with an embodiment, such interaction by the operator user with the branding plugin can comprise, for example, a process of customizing and look and feel of the operator's space hosted at the cloud infrastructure environment (e.g., internally facing webpages or externally facing webpages or consoles), such as those of the customer experience 1112.

In accordance with an embodiment, such interaction with the branding plugin can additionally comprise instructions for updating the theme of the operator's pages or consoles, e.g., the colors, branding, logos, trademarks, text font, text size, color palette. Once the operator user has finished making the desired changes/updates/customizations at the branding plugin, an instruction to save these changes can be received, whereupon the instructions can be converted into one or more calls to be passed to the configuration service. Such calls can, for example, comprise REST API calls.

In accordance with an embodiment, based on the interactions and instructions received from step 1121 at the branding plugin, the branding plugin can interact with the configuration service comprising various calls, such as REST API calls. Such calls ben be directed via a proxy, such as a SPLAT proxy, at 1122. The proxy can, in certain embodiments, handle certain aspects of authentication (e.g., authentication via one more methods such as authentication via an authentication service), authorization (e.g., authorization via one more methods such as authorization via an authorization process), as well as load balancing (e.g., load balancing via throttling), auditing and logging (e.g., logging records of interactions at an accessible memory).

In accordance with an embodiment, the proxy can forward the calls, e.g., REST API calls, to the configuration service at 1123 within the configuration service tenancy. The configuration service can perform checks to determine various characteristics associated with the received calls from the proxy.

In accordance with an embodiment, such checks can include, for example, whether the colors provided are within a correct color range, and if logos uploaded are the correct size. In this way, the configuration service can act as a validator to determine whether the desired inputs submitted by the operator user are valid for any given page or console. The configuration service (e.g., a user experience configuration service) can generate and process configuration artifacts (e.g., user experience configuration artifacts). The configuration service can, at 1124, then store these artifacts at a configuration staging bucket, which can be associated with a memory accessible by the configuration service. When an operator user is actively making changes, it is not desirable to publish such changes immediately after a call is received. It is for this reason that such changes are stored in a temporary staging bucket so that operator user can preview changes in bulk or in batches before such changes are published.

In accordance with an embodiment, in order to validate custom UX configurations, upon receiving, for example, uploads or other customized artifacts from an operator, (e.g., a brand logo), the system can perform checks, e.g., memory size, dimensions, not malicious (e.g., malicious script or html code), of a supported file type (supported file types can include, for example PNG or JPG formats). The systems and methods described can perform such checks depending on the artifact in question.

For example, the branding plugin can check dimensions and memory size of uploaded artifacts, and the UX configuration service can check for valid file type. If all checks pass, yet uploaded artifacts still break console code, then the uploaded/custom artifacts will not be pushed to the console. The console can fall back to all or some of a generic UX configuration, which would allow the console to continue to function. In some embodiments, if some uploaded custom artifacts pass validation, while other do no, the fall back scenario can be a combination of a default/generic UX configuration combined with other elements of a configured custom UX configuration.

In accordance with an embodiment, upon receiving a request to preview the changes made by the operator user to the operator's pages or consoles, the configuration service can, based on the artifacts stored in the staging bucket, transfer at 1125 such artifacts from the staging bucket to a configuration preview bucket at a service tenancy, such as an origin service tenancy. From this preview bucket, the console can render a preview of a page or console based upon the artifacts stored at the staging bucket. Such preview can comprise, for example, one, some, or all of the changes/customizations made by the operator user at the branding plugin. Such preview can be rendered 1127 via the service (e.g., origin service), and rendered, e.g., as a privately accessible website for use by the operator.

In accordance with an embodiment, the preview does not merely generate an image (displayed in the branding plugin user interface) as the preview of the console with new colors that the operator has selected. The preview also provides UI components and interactions with those components. Operators are provided with a dynamic way of previewing changes to their consoles where they can interact with the console plugins and the UI components without actually publishing changes.

In accordance with an embodiment, to provide such generation of a live preview of the console, the service provides an API that takes in the identifiers of the UX configuration (UxConfig) and theme (UxTheme) that the operator wants to preview, and the API returns a path along with other essential attributes that the console can use to load the UX configuration from.

In accordance with an embodiment, upon an instruction to publish the changes/customizations made by the operator user via the branding plugin, the configuration service can retrieve the stored artifacts in the staging bucket and transfer 1126 such artifacts to the configuration production bucket at the service tenancy. From there, the artifacts are cached 1128 by the service into its server hosts. The artifacts can then be served 1129 by the service, e.g., origin service, to the end user 1130, who can interact 1130 with the rendered page/console.

In accordance with an embodiment, because any changes in the configuration (e.g., user experience configuration) or theme (e.g., user experience theme) can affect all customer tenancies in a realm, it is important for the operators to preview their changes before such changes are published live. To support the preview functionality, the configuration service can maintain a plurality of separate buckets. The first two buckets can be fronted by a service (e.g., origin service), which can serve files from these buckets. The configuration production bucket 1110 can store all the configuration and theme artifacts that are published by an operator. Any changes in this bucket are seen by all the end customers of console. The configuration preview bucket 1109 can store configuration and theme artifacts so as to allow the operators to preview the changes before publishing them to the production bucket.

In accordance with an embodiment, the console can read a manifest file from configuration production bucket and the configuration preview bucket (only for previewing the changes) that act as an entry point for loading the configuration and themes in the console. All the other files and folders are references from the manifest file using relative paths hence making the folder structure flexible. The name and location of this file are governed by a contract between the configuration service and the console.

In accordance with an embodiment, a plurality of tenancies is displayed within FIG. 11, including the operator access tenancy 1101, the console configuration service tenancy 1105, the service tenancy 1108, and the customer tenancy 1113. Of these four tenancies, two can be exclusively operated and accessed by the cloud infrastructure environment provider, namely the console configuration tenancy 1105 and the service tenancy 1108. The operator access tenancy (referred to herein in some embodiments as the OAT) can comprise a tenancy that is set up/configured by the cloud infrastructure environment provider for the authorized use by the operator and the operator user, who can be configured as an administrator of the OAT. The customer tenancy is a tenancy of the operator from which its customers can access and interact with the customized consoles/pages of the operator that run within cloud infrastructure environment, which, upon access by a customer (e.g., end user 1130, is transparent to the end user.

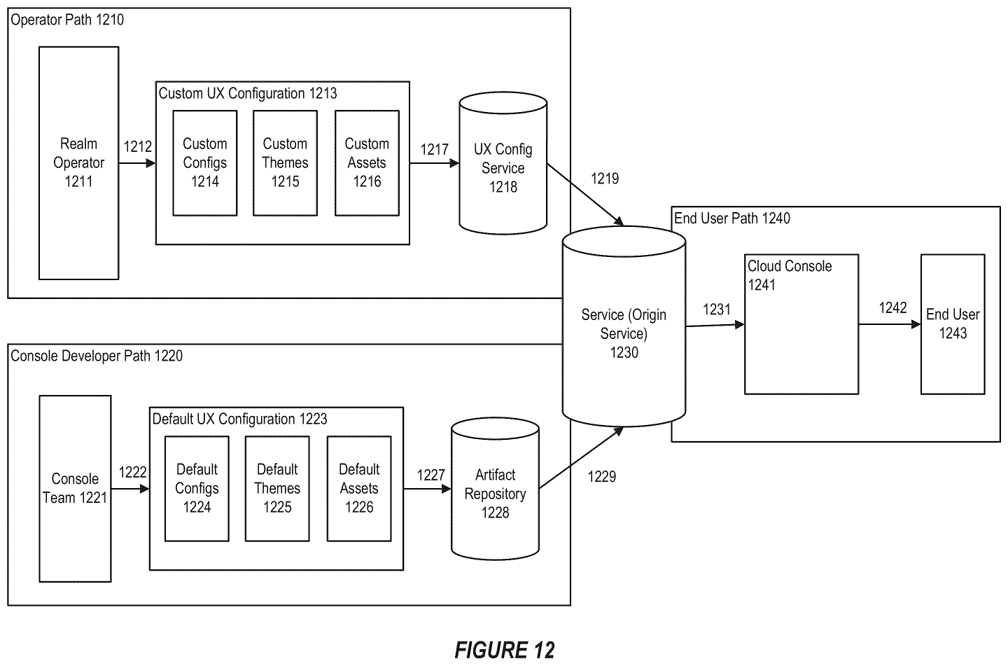

FIG. 12 depicts multiple paths for providing console customization, in accordance with an embodiment.

As illustrated in FIG. 12, in accordance with an embodiment, there can be provided a plurality of paths for providing console customization, including an operator path 1210, a console developer path 1220, and an end user path 1240.

In accordance with an embodiment, on the operator path 1210 (e.g., an operator of a cloud infrastructure environment, for example a PLC operator), a realm operator or operators 1211 can utilize a branding plugin 1212 to define/interact with a custom user experience configuration 1213 to define custom configuration 1214, custom themes 1215, and custom assets 1216. Custom configurations can comprise structures, such as JSON structures, with nested key-value pair fields. Configuration files can represent unique aspects of customization (for example, custom strings, branded html metadata, feature toggle overrides, nav registry overrides).

In accordance with an embodiment, configuration files are singletons—there can only be one of each type of config in a realm. Custom themes can comprise special configurations that define the styling cues (colors, fonts, layout) for the console. There can be multiple themes defined in a realm (for example, red theme, blue theme). Custom assets can comprise, e.g., images, icons, or fonts. In some embodiments, executable code (html, css, js) is not stored as assets. Assets can be theme agnostic (example, favicon), or theme-specific (example, colorized versions of logos).

In accordance with an embodiment, operators can utilize the branding plugin to administer custom UX configurations. The branding plugin can also allow operators to upload configs, assets and themes to UX configuration service. It can give operators real-time previews of their changes, and the ability to publish their changes to service, e.g., an origin service, after review.

In accordance with an embodiment, these operators are allowed to publish such as custom user experience configuration by uploading 1217 to a user experience configuration server 1218 to represent their branding/theming/customization within a realm (e.g., a PLC realm). Such customizations can be published 1219 to a service 1230, such as an origin service.

In accordance with an embodiment, the UX configuration service 1218 can provide functionality for custom UX configurations (e.g., CRUD (create, read, update, and delete) functionality), and allows the custom UX configurations to be published to a service, such as an origin service, in order to allow the console to consume them. This service is accessible to operators, as end users do not have to interact with this service. As such, the UX configuration service can be gated/protected by authentication and authorization services, and access can be restricted to users in an operator tenancy.

In accordance with an embodiment, the paths described above can support theme selection. When multiple themes are defined in a realm, the customized console can allow operator users to pick a preferred theme. An associated theme ID can be stored in console personalization service as a user-level preference. If the user has not selected a preferred theme or if the service is unavailable, console will fall back to the realm default theme (as set by, e.g., the console developer path).

In accordance with an embodiment, in order to render console with an active theme, a process of injecting CSS (cascading style sheets) styles at runtime can be provided. The console configuration service can tokenize every theme-able CSS property so that the values can be populated at runtime. For component colors, this means mapping every component color in console to one of the predefined palette colors.

In accordance with an embodiment, each defined/configured element of a custom UX configuration can be tokenized by, for example, the configuration service. Such tokenization can be utilized to populate a custom console, and can additionally be utilized in a debug/error checking mode.

In accordance with an embodiment, the UX configuration service can store UX configurations (config and asset files) in an object store. The service has two private buckets in object store-staging and production. This enables two-stage publishing for UX configurations. At the staging bucket, operators create and manage drafts of UX configurations. At the production bucket, once the operator is satisfied with the draft, an instruction can be received to tell the UX configuration service to publish it to the production bucket. The service, e.g., an origin service, can poll (e.g., at a configurable interval, such as every 3 minutes) the production bucket for changes to a published custom UX configuration and serves the custom UX configuration to all console users in the realm. A preview bucket at the service tenancy can be utilized to preview the console with the staging configurations applied.

In accordance with an embodiment, the UX configuration service can recognize/utilize two separate backend resources. These backend resources are transparent to console, however, the branding plugin needs to be aware of them. First, a UX Configuration backend resource can represent theme-agnostic bundle of common assets and common configs. This is a singleton resource—there can only be one UX configuration resource active per realm. Second, a UxTheme backend resource can represent a theme-specific bundle of config (e.g., theme.json) and assets. There can be multiple UxTheme resources defined per realm.

In accordance with an embodiment, on the console developer path 1220, a console team 1221 can pull/request 1222 a default user experience configuration 1223, which can comprise default configurations 1224, default themes 1225, and default assets 1226. The default user experience configuration can be merged 1227 at an artifact repository 1228, which can comprise a repository manager, and can be deployed 1229 to the service 1230, e.g., origin service, along with the custom user experience configuration supplied on the operator path. This default user experience configuration can be used in, for example, non-PLC realms (e.g., realms where no operator customizations are applied), and can also be used in PLC realms as a fallback scenario in an error situation, such as when a console is unable to load operator defined custom configurations.

In accordance with an embodiment, on an end user path 1240, when an end user 1243 calls to load 1242 a console 1241 (e.g., cloud console), console fetches 1231 the custom or default user experience configurations from the service 1230 (e.g., origin service) during initialization. It uses the fetched user experience configurations to render a themed/branded console/page.

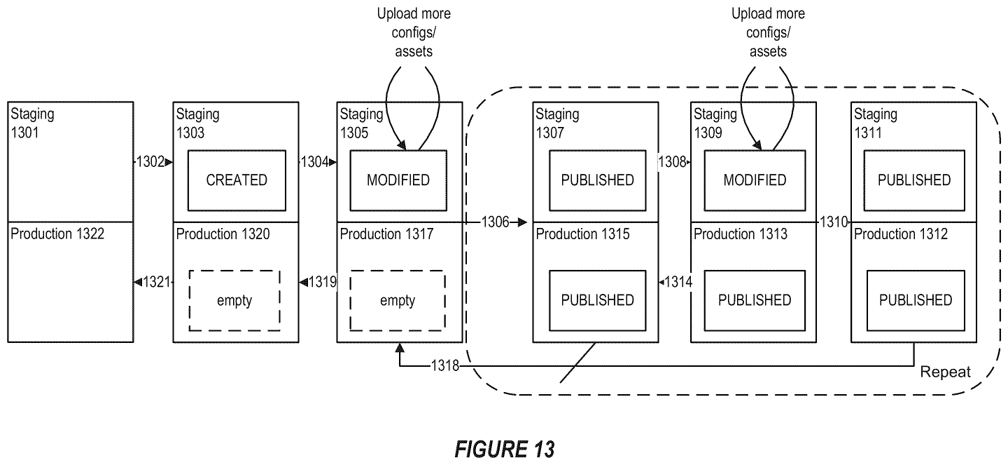

FIG. 13 is a lifecycle diagram for backend resources for console customization, in accordance with an embodiment.

As illustrated in FIG. 13, in accordance with an embodiment, each backend resource (described above int the context of a custom UX configuration 1213, which can comprise custom configurations 1214, custom themes 1215, and custom assets 1216) can go through a lifecycle depicted in FIG. 13 that map to UI operations/service APIs. These lifecycle states comprise staging bucket 1301, 1303, 1305, 1307, 1309, and 1311, and production bucket 1312, 1313, 1315, 1317, 1320, and 1322.

In accordance with an embodiment, operators, at 1302, can create a new empty custom UX configuration, in the CREATED state, in the staging bucket. From there, the operators can upload a first set of configurations and assets at 1304. The operators can then create a new draft of the custom UX configuration by, for example, uploading more configurations and assets. The resource is then in a MODIFIED state. They can create a new draft by uploading more configurations and assets to it (MODIFIED state) or discard the draft. Once satisfied, they publish 1306 the draft within the staging bucket or the production bucket.

In accordance with an embodiment, upon review of the resources in the staging bucket, if the operator desires to restart, the operator can again upload a set of first configurations and assets 1308, and then edit and upload more configurations and assets, leaving the resource again in a MODIFIED state. Once satisfied, they can publish 1310 the draft within the staging bucket or the production bucket. This cycle can repeat, together with discards 1314 of certain portions of the resource, until the operator is satisfied with the resources, at which point they can be published to the production bucket.

In accordance with an embodiment, the lifecycles additionally support unpublish 1318, which deletes a published custom UX configuration from the production bucket which purges the file from service, e.g., the origin service. Unpublishing also moves the custom UX configuration back to draft (MODIFIED) state in staging bucket, but does not delete the custom UX configuration from the system. Operators will still be able to access the draft if required. Finally, delete 1321 purges the custom UX configuration from the system. To ensure operators don't accidentally delete a custom UX configuration that is published (available to end users), delete operations only from the CREATED life cycle state, while discards 1319 may occur from the MODIFIED state.

In accordance with an embodiment, the depicted and described lifecycle state transitions supports several functionalities, including allowing for updating an already published UX configuration/UX Theme, as well as preventing deletion of a published UX configuration/UX Theme in a single step as deletion can be triggered by mistake which can break the console functionality for all end-users in that realm.

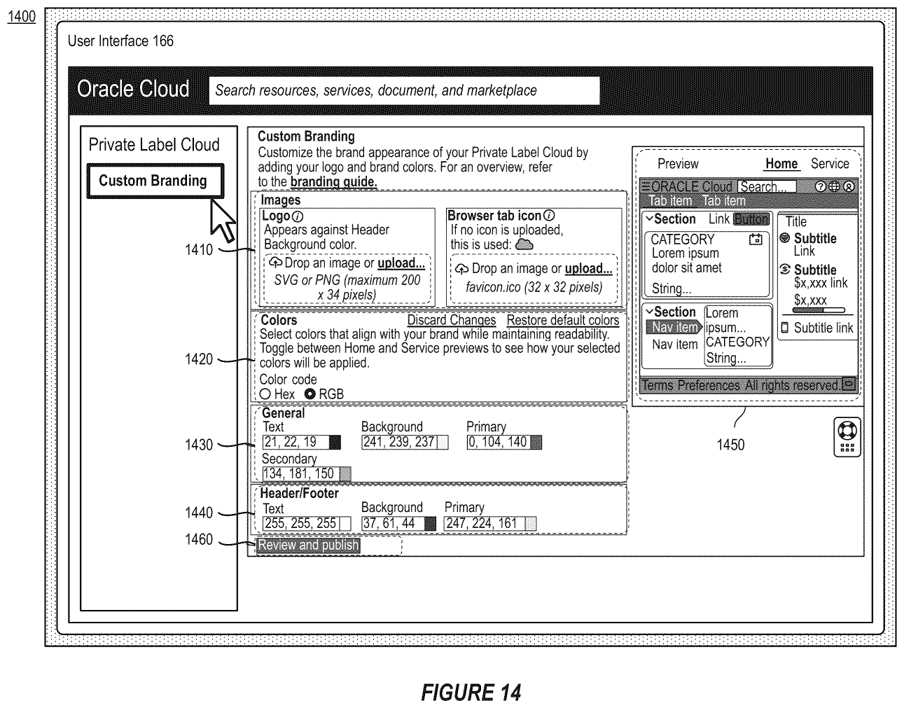

FIG. 14 is a depiction of a user interface for console customization, in accordance with an embodiment.

As illustrated in FIG. 14, in accordance with an embodiment, a user interface 1400 as produced by a branding user interface for console customization can comprise a number of components, including an images 1410 section, a colors section 1420, where the colors section is broken into different sections, including general colors 1430 and header/footer colors 1440.

In accordance with an embodiment, within the images section, an operator user may upload various assets, such as logos and images to be used for the browser tab, as indicated in the depicted embodiment. Such assets can, for example, then be added to a custom UX configuration resource, which can be utilized, as described above, to publish a live preview 1450.

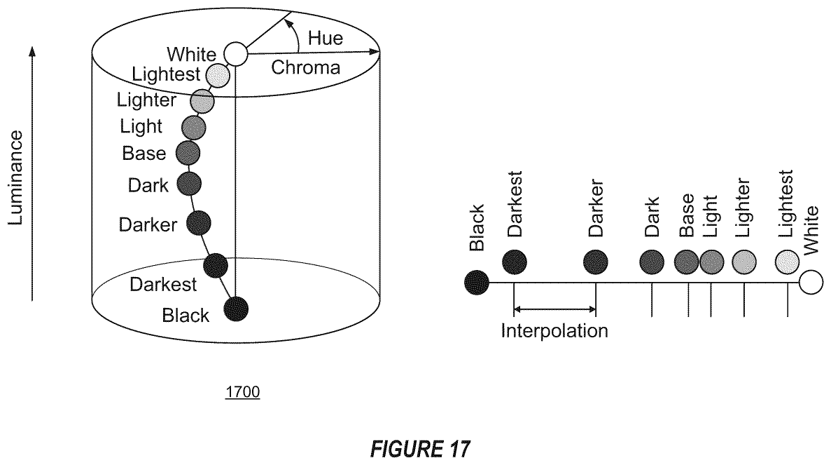

In accordance with an embodiment, a colors section 1420 can be displayed that allows an operator user to select a limited number of colors to be used for the customized console, including general colors 1430 as well as header and footer colors 1440. From these colors, using a palette generator (described below in the context of FIG. 17), the branding UI can generate a palette to be utilized within the operator's customized console. Such assets can, for example, then be added to a custom UX configuration resource, which can be utilized, as described above, to publish a live preview 1450.

In accordance with an embodiment, the UI 1400 additionally comprises a review and publish button 1460, which can allow an operator user to save the resources selected on the custom branding page to a custom UX configuration resource, which can, upon successful completion, be published via a service, such as an origin service.

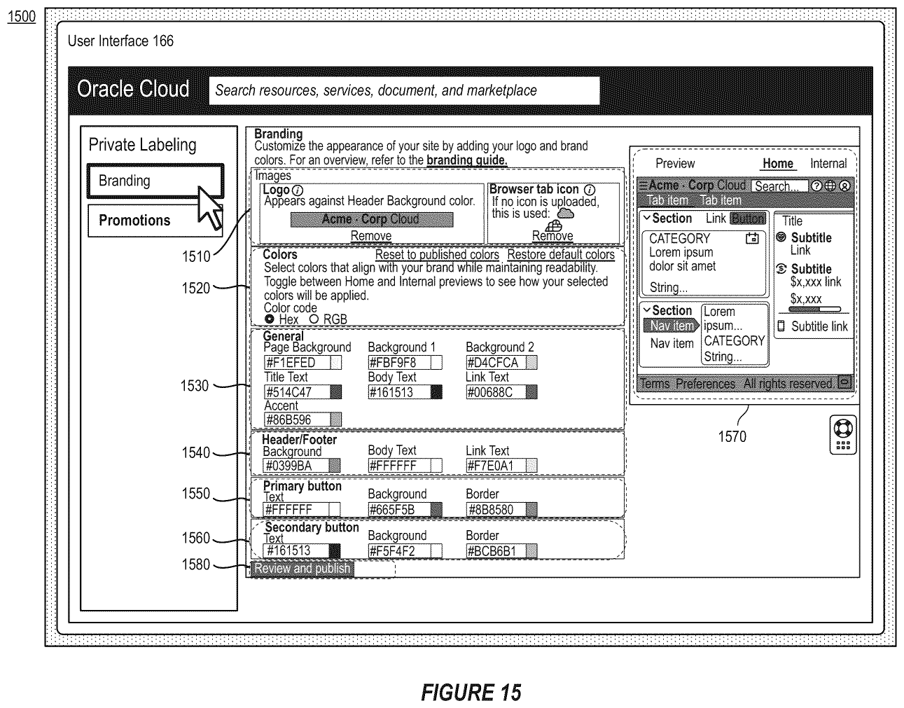

FIG. 15 is a depiction of a user interface for console customization, in accordance with an embodiment.

As illustrated in FIG. 15, in accordance with an embodiment, a user interface 1500 as produced by a branding user interface for console customization can comprise a number of components, including an images 1510 section, a colors section 1520, where the colors section is broken into different sections, including general colors 1530, header/footer colors 1540, primary button colors 1550, and secondary button colors 1560.

In accordance with an embodiment, within the images section, an operator user may upload various assets, such as logos and images to be used for the browser tab, as indicated in the depicted embodiment. Such assets can, for example, then be added to a custom UX configuration resource, which can be utilized, as described above, to publish a live preview 1570.

In accordance with an embodiment, a colors section 1520 can be displayed that allows an operator user to select a limited number of colors to be used for the customized console, including general colors 1530, header and footer colors 1540, primary button colors 1550, and secondary button colors 1560. From these colors, using a palette generator (described below in the context of FIG. 17), the branding UI can generate a palette to be utilized within the operator's customized console. Such assets can, for example, then be added to a custom UX configuration resource, which can be utilized, as described above, to publish a live preview 1570.

In accordance with an embodiment, the UI 1500 additionally comprises a review and publish button 1580, which can allow an operator user to save the resources selected on the custom branding page to a custom UX configuration resource, which can, upon successful completion, be published via a service, such as an origin service.

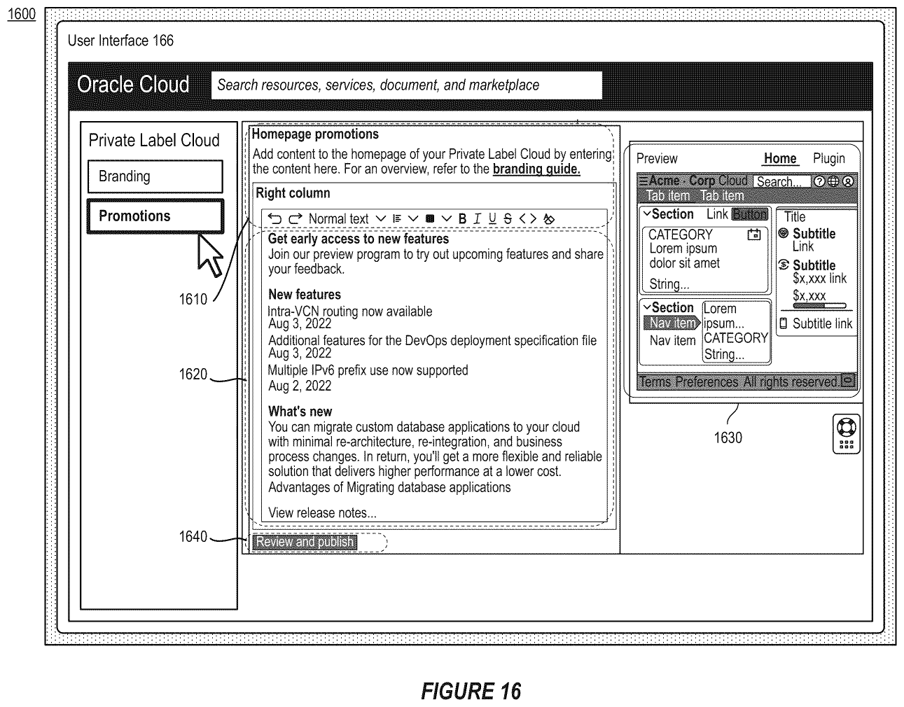

FIG. 16 is a depiction of a user interface for console customization, in accordance with an embodiment.

As illustrated in FIG. 16, in accordance with an embodiment, a user interface 1600 as produced by a branding user interface for console customization can comprise a number of components, including a homepage promotion 1610 section, which includes a text section 1620.

In accordance with an embodiment, within homepage promotions section 1610, an operator user may utilize, for example, dropdown menus or other selections to specify a portion of the console on which text, from text section 1620, can be entered, as well as formatting the text. The information from the homepage promotions section, as well as text entered within the text fields 1620 can be utilized in generating or modifying, for example, a custom UX configuration resource.

In accordance with an embodiment, the UI 1500 additionally comprises a live preview window 1630, which can show a live preview of the customized console, as well as a review and publish button 1640, which can allow an operator user to save the resources selected on the custom branding page to a custom UX configuration resource, which can, upon successful completion, be published via a service, such as an origin service.

FIG. 17 depicts a color space used for custom palette generation for console customization, in accordance with an embodiment.

As illustrated in FIG. 17, in accordance with an embodiment as described above, a custom console can be generated for an operator, such as an operator for a PLC environment. Such a custom console can comprise, for example, a custom logo (e.g., the operator's logo), as well as rendering the console in custom colors and a customized color palette, which can be applied to the header, footer, navigation menu, background, accents, or link colors.

In accordance with an embodiment, the custom palette generation can begin with having an operator user select a limited set of base colors (e.g., 7 colors) to be utilized in a generated custom console. These base colors can be defined from, for example, the branding plugin. From these base colors, the branding plugin can generate a palette of colors scaled by chroma and luminosity to generate all possible colors to be used within the custom console. Such custom palette generation provides for improved compute efficiency.

In accordance with an embodiment, using a hue-chroma-luminosity color space 1700, and inputting the limited set of base colors as defined by the operator user, the branding plugin can generate a custom palette for use by the operator user in designing and customizing a console. As an example, by inputting 7 base colors, the custom palette generator can generate over 50 unique colors to be used within the operator's custom console. This enables consistency, and reduces developer and designer overhead in having to track and maps dozens of unique colors.

In accordance with an embodiment, the systems can utilize a HCL (Hue-Chroma-Luminosity) color space for palette generation. This can comprise a cylindrical color space specifically designed for ensuring scaled colors are perceptually similar. Standard RGB and HSL color spaces do not support perceptual mapping, making them unsuitable for palette generation.

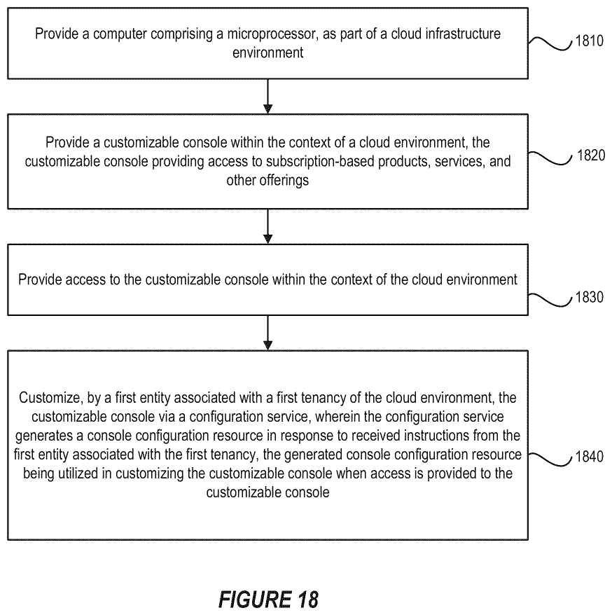

FIG. 18 is a flowchart of a method for customizable console generation, in accordance with an embodiment.

As illustrated in FIG. 18, in accordance with an embodiment the method can, at step 1810, provide a computer comprising a microprocessor, as part of a cloud infrastructure environment.

In accordance with an embodiment, the method can, at step 1820, provide a customizable console within the context of the cloud environment, the customizable console providing access to subscription-based products, services, and other offerings.

In accordance with an embodiment, the method can, at step 1830, provide access to the customizable console within the context of the cloud environment.

In accordance with an embodiment, the method can, at step 1840, customize, by a first entity associated with a first tenancy of the cloud environment, the customizable console via a configuration service, wherein the configuration service generates a console configuration resource in response to received instructions from the first entity associated with the first tenancy, the generated console configuration resource being utilized in customizing the customizable console when access is provided to the customizable console.

In accordance with an embodiment, the generated console configuration resource can be stored at a first storage location.

In accordance with an embodiment, the first storage location can comprise a preview storage. Based upon the generated console configuration resource being stored at the preview storage location, a live preview of the console is generated for use within a console configuration user interface.

In accordance with an embodiment, the method can tokenize the generated console configuration resource prior to being stored at the first storage location and the second storage location.

In accordance with an embodiment, the received instructions can comprise of a set of selected colors for use within the customizable console. Based upon the received instructions, the method can generate a color palette comprising a plurality of colors for use within the customizable console, the color palette comprising colors having perceptual similarity to the set of colors.

In accordance with an embodiment, the method can tokenize each of the plurality of colors of the generated color palette.

In accordance with an embodiment, a further instruction can be received to publish the customizable console.

Upon receiving such an instruction, the generated console configuration resource can be stored at a second storage location, the second storage location comprising a production storage. A live version of the customizable console can be generated by polling the storage location to detect the generated console configuration resource stored therein. Such a live version can be made accessible by a customer of the cloud environment.

In accordance with an embodiment, the generated console configuration resource can follow a lifecycle that supports generation, modification, deletion and unpublishing.

In accordance with an embodiment, prior to receiving instructions at the configuration service, the instructions can be received at a proxy. The proxy, in turn, can perform at least one authentication, authorization, auditing, and load balancing.

In accordance with an embodiment, the received instructions can be received from the first tenancy of the cloud environment, the first tenancy being associated with a first identity provider. The configuration service can be associated with a second tenancy of the cloud environment, the second tenancy being associated with a second identity provider.

### Customizable Console Debug Mode

In accordance with an embodiment, the systems and methods described herein can support a debugging mode (also referred to herein as “debug mode”) for customizable console. Debug mode can comprise a system and method to determine whether all parts of custom UX configuration resource for a customized console are valid for generating a customized console. Such a debug mode allows for the easy detection and identification of bugs or errors within a custom UX configuration, and to determine whether a customized console can be generated without errors based when such customized console is based upon a custom UX configuration resource.

In accordance with an embodiment, the debug mode, via, e.g., a debug service, can generate a modified version of a preview of a customized console which based upon a custom UX configuration resource. This modified version of the preview of the customized console can, for example, be generated in a manner which, when displayed via a user interface, can allow for easy detection of portions or parts of a customized console that is configured correctly (e.g., correctly tokenized), as well as portions or parts of a customized console that are configured incorrectly (e.g., not tokenized or would cause a console to fail upon attempting to render).

In accordance with an embodiment, in generating the modified version of the preview of the customized console by the debug service, the customized console can be generated with a color palette that is generated with brightly saturated hues (such a color palette does would not, generally, be based upon the color palette selected and generated for the operator, but would be generated to as to have distinct color differences between portions of the modified version of the preview so as to allow quick identification of certain portions of the preview).

Then, in generating the modified version of the preview, the debug service can colorize any-tokenized elements, as well as elements that are configured to render without error, of the customized console in certain ones of the generated color palette. Any non-tokenized elements of the modified preview can be generated in different and distinctive colors of the color palette so as to provide for easy visual detection of portions of the customized console that are not tokenized, or would otherwise cause an error in a rendered customized console, or otherwise cause the customized console not to render for view by a customer of the cloud infrastructure environment.

In accordance with an embodiment, the debug mode can be run prior to a custom UX configuration resource being saved to a production bucket so that compute resources are saved and the systems are made more efficient.

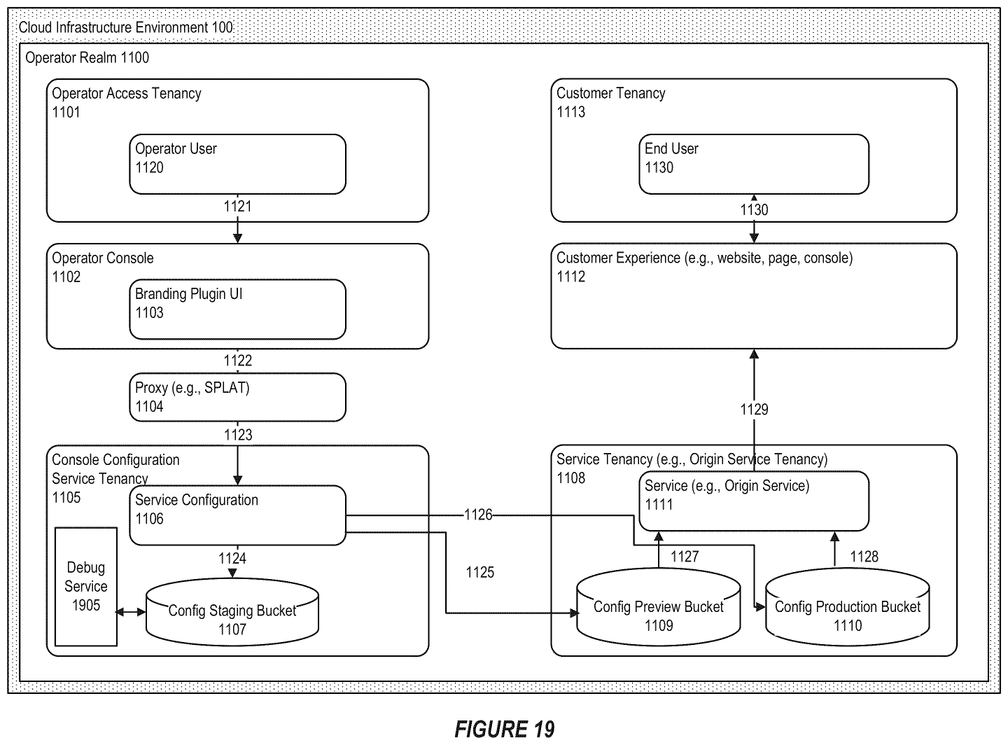

FIG. 19 illustrates an architecture for providing debug mode for console customization, in accordance with an embodiment.

As illustrated in FIG. 19, in accordance with an embodiment, within a cloud infrastructure environment 100, there can be provided/defined an operator realm 1100, which can be associated with an operator of the cloud infrastructure environment, such as that described above. A cloud infrastructure provider (e.g., Oracle Cloud Infrastructure, OCI)) can supply an operator, for example an OCI customer operating as a reseller, with one or more cloud computing environments, such as private label cloud environments, which can have defined therein an operator realm 1100.

In accordance with an embodiment, defined within or in relation to the operator realm there can be a number of tenancies, such as an operator access tenancy 1101, a console configuration service tenancy 1105, a service tenancy 1108, and a customer tenancy 1113.

In accordance with an embodiment, from an operator access tenancy 1101, a user, such as a user of the operator 1120, can interact with an operator console 1102 via a, for example, branding plugin user interface 1103. This can be in the form of, for example, a privately accessible website that provides, via the branding plugin user interface, customization options for the operator's website that is hosted at/provided by the cloud infrastructure environment 100.

In accordance with an embodiment, at 1121, an operator or an authorized user of the operator, such as an operator user 1120, can interact with the branding plugin, e.g., via a web interface or other API, within the operator console 1102.

In accordance with an embodiment, such interaction by the operator user with the branding plugin can comprise, for example, a process of customizing and look and feel of the operator's space hosted at the cloud infrastructure environment (e.g., internally facing webpages or externally facing webpages or consoles), such as those of the customer experience 1112.

In accordance with an embodiment, such interaction with the branding plugin can additionally comprise instructions for updating the theme of the operator's pages or consoles, e.g., the colors, branding, logos, trademarks, text font, text size, color palette. Once the operator user has finished making the desired changes/updates/customizations at the branding plugin, an instruction to save these changes can be received, whereupon the instructions can be converted into one or more calls to be passed to the configuration service. Such calls can, for example, comprise REST API calls.

In accordance with an embodiment, based on the interactions and instructions received from step 1121 at the branding plugin, the branding plugin can interact with the configuration service comprising various calls, such as REST API calls. Such calls ben be directed via a proxy, such as a SPLAT proxy, at 1122. The proxy can, in certain embodiments, handle certain aspects of authentication (e.g., authentication via one more methods such as authentication via an authentication service), authorization (e.g., authorization via one more methods such as authorization via an authorization process), as well as load balancing (e.g., load balancing via throttling), auditing and logging (e.g., logging records of interactions at an accessible memory).

In accordance with an embodiment, the proxy can forward the calls, e.g., REST API calls, to the configuration service at 1123 within the configuration service tenancy. The configuration service can perform checks to determine various characteristics associated with the received calls from the proxy.

In accordance with an embodiment, such checks can include, for example, whether the colors provided are within a correct color range, and if logos uploaded are the correct size. In this way, the configuration service can act as a validator to determine whether the desired inputs submitted by the operator user are valid for any given page or console. The configuration service (e.g., a user experience configuration service) can generate and process configuration artifacts (e.g., user experience configuration artifacts). The configuration service can, at 1124, then store these artifacts at a configuration staging bucket, which can be associated with a memory accessible by the configuration service.

When an operator user is actively making changes, it is not desirable to publish such changes immediately after a call is received. It is for this reason that such changes are stored in a temporary staging bucket so that operator user can preview changes in bulk or in batches before such changes are published.

In accordance with an embodiment, in order to validate custom UX configurations, upon receiving, for example, uploads or other customized artifacts from an operator, (e.g., a brand logo), the system can perform checks, e.g., memory size, dimensions, not malicious (e.g., malicious script or html code), of a supported file type (supported file types can include, for example PNG or JPG formats). The systems and methods described can perform such checks depending on the artifact in question.

For example, the branding plugin can check dimensions and memory size of uploaded artifacts, and the UX configuration service can check for valid file type. Finally, if all checks pass, yet uploaded artifacts still break console code, then the uploaded/custom artifacts will not be pushed to the console. The console can fall back to all or some of a generic UX Configuration, which would allow the console to continue to function.

In some embodiments, if some uploaded custom artifacts pass validation, while other do no, the fall back scenario can be a combination of a default/generic UX configuration combined with other elements of a configured custom UX configuration.

In accordance with an embodiment, upon receiving a request to preview the changes made by the operator user to the operator's pages or consoles, the configuration service can, based on the artifacts stored in the staging bucket, transfer at 1125 such artifacts from the staging bucket to a configuration preview bucket at a service tenancy, such as an origin service tenancy. From this preview bucket, the console can render a preview of a page or console based upon the artifacts stored at the staging bucket. Such preview can comprise, for example, one, some, or all of the changes/customizations made by the operator user at the branding plugin. Such preview can be rendered 1127 via the service (e.g., origin service), and rendered, e.g., as a privately accessible website for use by the operator.

In accordance with an embodiment, the preview does not merely generate an image (displayed in the branding plugin user interface) as the preview of the console with new colors that the operator has selected. The preview also provides UI components and interactions with those components. Operators are provided with a dynamic way of previewing changes to their consoles where they can interact with the console plugins and the UI components without actually publishing changes.

In accordance with an embodiment, to provide such generation of a live preview of the console, the service provides an API that takes in the identifiers of the UX configuration (UxConfig) and theme (UxTheme) that the operator wants to preview, and the API returns a path along with other essential attributes that the console can use to load the UX configuration from.

In accordance with an embodiment, upon an instruction to publish the changes/customizations made by the operator user via the branding plugin, the configuration service can retrieve the stored artifacts in the staging bucket and transfer 1126 such artifacts to the configuration production bucket at the service tenancy. From there, the artifacts are cached 1128 by the service into its server hosts. The artifacts can then be served 1129 by the service, e.g., origin service, to the end user 1130, who can interact 1130 with the rendered page/console.

In accordance with an embodiment, because any changes in the configuration (e.g., user experience configuration) or theme (e.g., user experience theme) can affect all customer tenancies in a realm, it is important for the operators to preview their changes before such changes are published live. To support the preview functionality, the configuration service can maintain three separate buckets. The first two buckets can be fronted by a service (e.g., origin service), which can serve files from these buckets. The configuration production bucket 1110 can store all the configuration and theme artifacts that are published by an operator. Any changes in this bucket are seen by all the end customers of console. The configuration preview bucket 1109 can store configuration and theme artifacts so as to allow the operators to preview the changes before publishing them to the production bucket.

In accordance with an embodiment, the console can read a manifest file from configuration production bucket and the configuration preview bucket (only for previewing the changes) that act as an entry point for loading the configuration and themes in the console. All the other files and folders are references from the manifest file using relative paths hence making the folder structure flexible. The name and location of this file are governed by a contract between the configuration service and the console.

In accordance with an embodiment, a debug service 1905 can provided within the could infrastructure environment, where the debug service can interact with the staging bucket in order to generate a modified preview of a customized console for use in quickly identifying errors or potential errors that would occur if/when a customized console is generated based upon a custom UX configuration resource that is stored at the staging bucket. As described above, the debug service can, based upon its interaction with the staging bucket (or another one of the buckets, such as the preview bucket or the production bucket), generate a modified preview to be displayed via a user interface.

In accordance with an embodiment, in generating the modified version of the preview of the customized console by the debug service, the customized console can be generated with a color palette that is generated with brightly saturated hues (such a color palette does would not, generally, be based upon the color palette selected and generated for the operator, but would be generated to as to have distinct color differences between portions of the modified version of the preview so as to allow quick identification of certain portions of the preview).

Then, in generating the modified version of the preview, the debug service can colorize any-tokenized elements, as well as elements that are configured to render without error, of the customized console in certain ones of the generated color palette. Any non-tokenized elements of the modified preview can be generated in different and distinctive colors of the color palette so as to provide for easy visual detection of portions of the customized console that are not tokenized, or would otherwise cause an error in a rendered customized console, or otherwise cause the customized console not to render for view by a customer of the cloud infrastructure environment.

In accordance with an embodiment, a plurality of tenancies is displayed within FIG. 19, including the operator access tenancy 1101, the console configuration service tenancy 1105, the service tenancy 1108, and the customer tenancy 1113. Of these four tenancies, two can be exclusively operated and accessed by the cloud infrastructure environment provider, namely the console configuration tenancy 1105 and the service tenancy 1108. The operator access tenancy (OAT) can comprise a tenancy that is set up/configured by the cloud infrastructure environment provider for the authorized use by the operator and the operator user, who can be configured as an administrator of the OAT. The customer tenancy is a tenancy of the operator from which its customers can access and interact with the customized consoles/pages of the operator that run within cloud infrastructure environment, which, upon access by a customer (e.g., end user 1130, is transparent to the end user.

In accordance with an embodiment, the debug service can be provided within the context of a tenancy exclusively owned and operated by the cloud infrastructure provider.

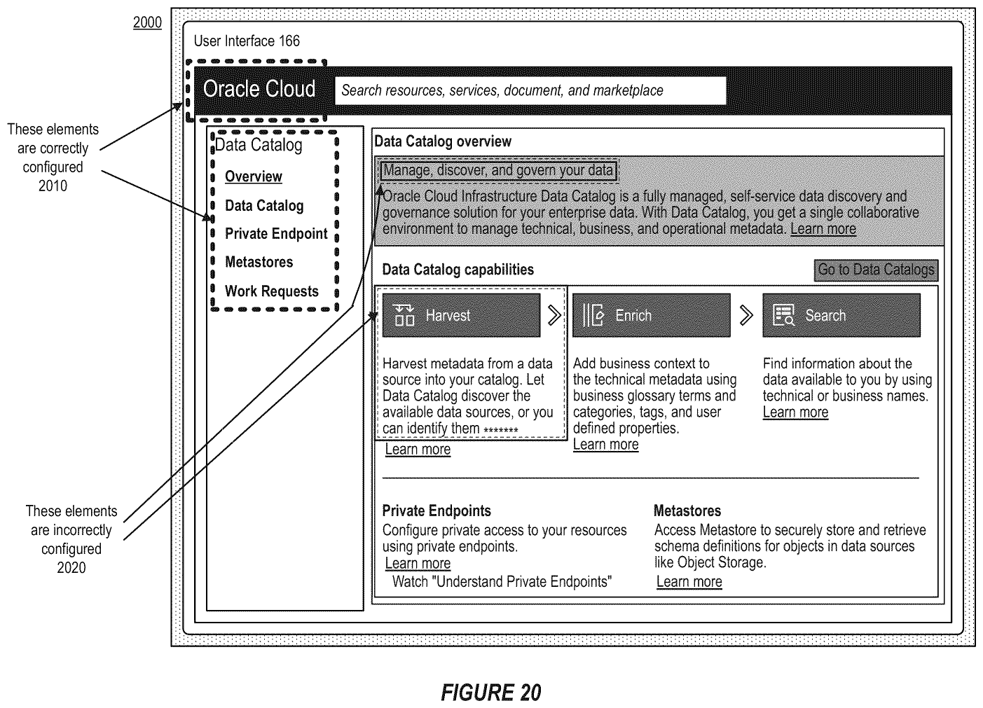

FIG. 20 shows a screenshot of debug mode, in accordance with an embodiment.

In accordance with an embodiment, as produced at a graphical user interface 166, a debug service can produce a modified preview 2000 of a console based upon, for example, a custom UX configuration resource as set by an operator or a user thereof.

In accordance with an embodiment, as depicted in various shadings of the Figure, correctly configured and tokenized portions of the console 2010 can be rendered in certain hues of a generated palette which are indicative of those portions of the console being configured and tokenized correctly.

In accordance with an embodiment, as depicted in various shadings within the figure, incorrectly configured and/or non-tokenized portions of the console 2020 can be rendered in certain hues of a generated palette which are indicative of those portions of the console being configured in correctly or not tokenized.

In accordance with an embodiment, then, based upon this modified rendering of a customized console, various portions of the custom UX configuration resource can be identified quickly as being either non-tokenized or incorrectly configured. In such cases, then, error resolution can be handled prior to the custom UX configuration resource being transferred to the production bucket, where such errors or non-tokenized artifacts would cause a console rendered for an under user to display incorrectly, or even be defaulted completely or partially to a generic user interface.

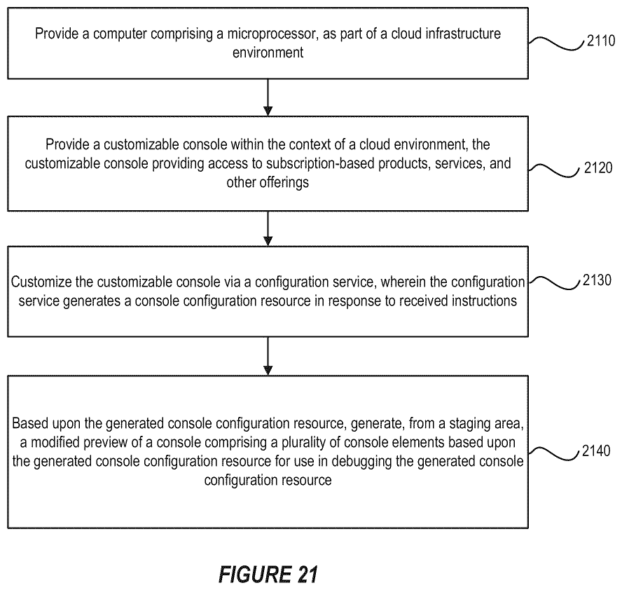

FIG. 21 is a flowchart of a method for console debug mode for custom console, in accordance with an embodiment.

In accordance with an embodiment, the method can, at step 2110, can provide a computer comprising a microprocessor.

In accordance with an embodiment, the method can, at step 2120, provide a customizable console within the context of a cloud environment, the customizable console providing access to subscription-based products, services, and other offerings.

In accordance with an embodiment, the method can, at step 2130, customize the customizable console via a configuration service, wherein the configuration service generates a console configuration resource in response to received instructions.

In accordance with an embodiment, the method can, at step 2140, based upon the generated console configuration resource, generate, from a staging area, a modified preview of a console comprising a plurality of console elements based upon the generated console configuration resource for use in debugging the generated console configuration resource.

In accordance with an embodiment, generating the modified preview of the console can comprise generating a color palette for use in the modified preview, the color palette comprising a plurality of colors with high saturation.

In accordance with an embodiment, a first set of the plurality of colors can be utilized within the modified preview to indicate a first set of console elements that correspond to tokenized assets within the generated console configuration resource.

In accordance with an embodiment, a second set of the plurality of colors can be utilized within the modified preview to indicate a second set of console elements that correspond to non-tokenized assets within the generated console configuration resource.

In accordance with an embodiment, the first set of console elements can be distinct from the second set of console elements.

In accordance with an embodiment, the modified preview can be generated by a debug service running in the context of a first tenancy of the cloud infrastructure environment.

In accordance with an embodiment, the received instructions can be received from the context of a second tenancy of the cloud infrastructure environment.

In accordance with an embodiment, the first tenancy is associated with a first identify provider, and the second tenancy can be associated with a second identity provider.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A method comprising:
providing a computer comprising a microprocessor;
providing a customizable console within the context of a cloud environment, the customizable console providing access to subscription-based products, services, and other offerings;
customizing the customizable console via a configuration service, wherein the configuration service generates a console configuration resource in response to received instructions;
based upon the generated console configuration resource, generating, from a staging area, a modified preview of a console comprising a plurality of console elements based upon the generated console configuration resource for use in debugging the generated console configuration resource.

2. The method of claim 1, wherein the generating the modified preview of the console comprises:
generating a color palette for use in the modified preview, the color palette comprising a plurality of colors with high saturation.

3. The method of claim 2,
wherein a first set of the plurality of colors are utilized within the modified preview to indicate a first set of console elements that correspond to tokenized assets within the generated console configuration resource.

4. The method of claim 3,
wherein a second set of the plurality of colors are utilized within the modified preview to indicate a second set of console elements that correspond to non-tokenized assets within the generated console configuration resource.

5. The method of claim 4,
wherein the first set of console elements are distinct from the second set of console elements.

6. The method of claim 1,
wherein the modified preview is generated by a debug service running in the context of a first tenancy of the cloud infrastructure environment.

7. The method of claim 6,
wherein the received instructions are received from the context of a second tenancy of the cloud infrastructure environment.

8. The method of claim 7,
wherein the first tenancy is associated with a first identify provider; and
wherein the second tenancy is associated with a second identity provider.

9. A system comprising:
a computer comprising a microprocessor, wherein the computer is configured to perform a method comprising:
providing a customizable console within the context of a cloud environment, the customizable console providing access to subscription-based products, services, and other offerings;
customizing the customizable console via a configuration service, wherein the configuration service generates a console configuration resource in response to received instructions;
based upon the generated console configuration resource, generating, from a staging area, a modified preview of a console comprising a plurality of console elements based upon the generated console configuration resource for use in debugging the generated console configuration resource.

10. The system of claim 9, wherein the generating the modified preview of the console comprises:
generating a color palette for use in the modified preview, the color palette comprising a plurality of colors with high saturation.

11. The system of claim 10,
wherein a first set of the plurality of colors are utilized within the modified preview to indicate a first set of console elements that correspond to tokenized assets within the generated console configuration resource.

12. The system of claim 11,
wherein a second set of the plurality of colors are utilized within the modified preview to indicate a second set of console elements that correspond to non-tokenized assets within the generated console configuration resource.

13. The system of claim 12,
wherein the first set of console elements are distinct from the second set of console elements.

14. The system of claim 9,
wherein the modified preview is generated by a debug service running in the context of a first tenancy of the cloud infrastructure environment.

15. The system of claim 14,
wherein the received instructions are received from the context of a second tenancy of the cloud infrastructure environment.

16. The system of claim 15,
wherein the first tenancy is associated with a first identify provider; and
wherein the second tenancy is associated with a second identity provider.

17. A non-transitory computer readable storage medium having instructions thereon, which when read and executed cause a computer to perform steps comprising:
providing a customizable console within the context of a cloud environment, the customizable console providing access to subscription-based products, services, and other offerings;
customizing the customizable console via a configuration service, wherein the configuration service generates a console configuration resource in response to received instructions;
based upon the generated console configuration resource, generating, from a staging area, a modified preview of a console comprising a plurality of console elements based upon the generated console configuration resource for use in debugging the generated console configuration resource.

18. The non-transitory computer readable storage medium of claim 17, wherein the generating the modified preview of the console comprises:
generating a color palette for use in the modified preview, the color palette comprising a plurality of colors with high saturation.

19. The non-transitory computer readable storage medium of claim 18,
wherein a first set of the plurality of colors are utilized within the modified preview to indicate a first set of console elements that correspond to tokenized assets within the generated console configuration resource.

20. The non-transitory computer readable storage medium of claim 19,
wherein a second set of the plurality of colors are utilized within the modified preview to indicate a second set of console elements that correspond to non-tokenized assets within the generated console configuration resource.

21. The non-transitory computer readable storage medium of claim 20,
wherein the first set of console elements are distinct from the second set of console elements.

22. The non-transitory computer readable storage medium of claim 17,
wherein the modified preview is generated by a debug service running in the context of a first tenancy of the cloud infrastructure environment.

23. The non-transitory computer readable storage medium of claim 22,
wherein the received instructions are received from the context of a second tenancy of the cloud infrastructure environment.

24. The non-transitory computer readable storage medium of claim 23,
wherein the first tenancy is associated with a first identify provider; and
wherein the second tenancy is associated with a second identity provider.
